(19) United States
(12) Patent Application Publication
(10) Pub. No.: US 2014/0123827 A1
(43) Pub. Date: May 8, 2014

(54) Method for Producing at Least One Cutting Line Segment of a Cutting Line

(71) Applicants: Rudolf Fuchs, Neuhausen (DE); Ivo Gruber, Niklaus (CH); Joe Lauber, Zermatt (CH); Urs Karlen, Stalden (CH); Milan Bozic, Solothurn (CH); Arnold Hug, Gamsen (CH)

(72) Inventors: Rudolf Fuchs, Neuhausen (DE); Ivo Gruber, Niklaus (CH); Joe Lauber, Zermatt (CH); Urs Karlen, Stalden (CH); Milan Bozic, Solothurn (CH); Arnold Hug, Gamsen (CH)

(73) Assignee: Robert Bosch GmbH, Stuttgart (DE)

(21) Appl. No.: 14/002,750

(22) PCT Filed: Mar. 2, 2012
(86) PCT No.: PCT/EP2012/000917

§ 371 Date: Jan. 13, 2014

(30) Foreign Application Priority Data
Mar. 3, 2011 (DE) 10 2011 005 034.5

(51) Int. Cl. B27B 17/00

(52) U.S. Cl. CPC B27B 17/00
USPC 83/830; 76/47.1

(57) ABSTRACT

A method for producing at least one cutting line segment of a cutting line, having at least one cutter support element and one cutter element, comprises, in a first step at least one powder is mixed with at least one binder in a mixing device to produce a feedstock.

### PRIOR ART

Methods for producing a cutting strand segment of a cutting strand are already known. The cutting strand segment comprises in this case a cutter carrier element and a cutting element.

### DISCLOSURE OF THE INVENTION

Proposed is a method for producing at least one cutting strand segment of a cutting strand which comprises at least one cutter carrier element and a cutting element, wherein, in a first step, a powder is mixed with a binder in a mixing device to form a feedstock. A “cutting strand segment” should be understood here as meaning in particular a segment of a cutting strand, said segment being provided to be connected to further segments of the cutting strand in order to form the cutting strand. Preferably, the cutting strand segment is in the form of a chain link which is connected to further cutting strand segments in the form of chain links in order to form the cutting strand, which is preferably in the form of a cutting chain. A “cutting strand” should be understood here as meaning in particular a unit composed of cutting strand segments, said unit being provided to locally undo atomic cohesion of a workpiece to be machined, in particular by means of a mechanical parting-off process and/or by means of mechanical removal of material particles of the workpiece. Preferably, the cutting strand is provided to separate the workpiece into at least two physically separate parts and/or to at least partially part off and/or remove material particles of the workpiece starting from a surface of the workpiece. The cutting strand is particularly preferably in the form of a cutting chain. The cutting strand segments of the cutting strand are thus preferably in the form of chain links. In this case, the cutting strand segments can be connected together detachably, for example by means of a chain joint etc., and/or non-detachably. However, it is also conceivable for the cutting strand to be in the form of a cutting band and/or cutting line. When the cutting strand is in the form of a cutting band and/or cutting line, the cutting strand segments are fixed directly to the cutting band and/or to the cutting line. The cutting strand segments can in this case be arranged on the cutting band and/or on the cutting line in a manner spaced apart from one another and/or in direct contact with one another.

A “cutter carrier element” should be understood here as meaning in particular an element to which at least one cutting element for parting off and/or for removing material particles of a workpiece to be machined is fixed. Particularly preferably, the cutter carrier element is connected cohesively to the cutting element. The expression “mixing device” is intended here to define in particular a device, in particular a machine, which is provided to mix materials, in particular pulverulent materials, with one another and/or to compact the materials. Preferably, the materials, in particular the at least one powder and the at least one binder, are mixed together and/or compacted by means of the mixing device in a stirring movement to form a feedstock. However, it is also conceivable for the materials to be mixed with one another to form a feedstock by means of some other movement and/or by means of some other method that appears appropriate to a person skilled in the art. In this case, the at least one powder can consist merely of an element, for example iron, or it can consist of a plurality of alloying elements. Particularly preferably, the powder is sinterable. The at least one binder is formed preferably by a polymeric binder, for example a wax and/or a plastic, in particular a thermoplastic. However, it is also conceivable for a plurality of binders to be mixed with the powder and or a powder mixture in order to mix a feedstock. A “feedstock” should be understood here in particular as meaning a starting material, in particular homogeneous granules, which is fed to a machine, in particular an injection-molding machine, and is processed by means of the machine in at least one or more working steps. Thus, the feedstock is preferably in the form of homogeneous granules. By means of the configuration of the method according to the invention, a cutting strand segment can advantageously be produced cost-effectively. Furthermore, by means of the method, a large variety with regard to the materials to be processed to produce the cutting strand segment can be achieved.

It is furthermore proposed that the powder used is a metal powder. Preferably, a hard metal powder is used. Preferably, the hard metal powder consists of tungsten carbide as the hard material or base powder and cobalt as the binding phase and/or of titanium carbide and titanium nitride as hard materials and nickel, cobalt and molybdenum as the binding phase. However, it is also conceivable for the metal powder to consist of some other composition that appears appropriate to a person skilled in the art. Preferably, the method is in the form of a metal injection-molding (MIM) method. Advantageously, a high hardness, high wear resistance and in particular high hot hardness of the cutting strand segment can be achieved.

In an alternative configuration of the method, it is proposed that the powder used is a ceramic powder. Preferably, the method is in the form of a ceramic injection-molding (CIM) method. Preferably, the ceramic powder consists of oxide ceramics, silicate ceramics, nitride ceramics and/or translucent ceramic. However, it is also conceivable for the powder used to be a carbide powder. Advantageously, a robust cutting strand segment can be achieved which is suitable for high cutting speeds.

Advantageously, in a further step, the feedstock is brought into a form of the cutting strand segment by means of an injection-molding operation, wherein the cutter carrier element and the cutting element are formed integrally with one another. A “form” should be understood here as meaning in particular a geometric shape of the cutting strand segment which the cutting strand segment has in order to fulfill at least one function. Particularly preferably, the cutter carrier element and the cutting element are produced jointly in one injection-molding operation. Thus, the cutter carrier element and the cutting element are connected together preferably cohesively. Preferably, the injection-molding operation produces a green part of the cutting strand segment. Preferably, thermoplastic injection-molding machines are used for the injection-molding operation. Advantageously, a cutting strand segment can be produced which has a complex component structure. Furthermore, a cutting strand segment can advantageously be produced cost-effectively.

Furthermore, it is proposed that, in a further step, the injection-molded cutting strand segment is subjected to chemical binder removal. Preferably, by means of the chemical binder removal, the at least one binder is released from the green part. This produces a brown part, in particular when metal powder is used prior to the injection-molding operation, or a white part, in particular when ceramic powder is used prior to the injection-molding operation, of the cutting strand segment. In an alternative configuration, it is proposed that, in a further step, the cutting strand segment is subjected to thermal binder removal. Preferably, by means of the thermal binder removal, the at least one binder is released from the green part. However, it is also conceivable for the binder to be removed from the green part of the cutting strand segment by means of some other method that appears appropriate to a person skilled in the art. However, furthermore, it is also conceivable for thermal binder removal and subsequently an additional chemical binder removal to take place. Advantageously, the at least one binder can be extracted from the green part of the cutting strand segment for further processing.

Preferably, in a further step, the cutting strand segment, in particular the brown body of the cutting strand segment, is sintered. In particular, the sintered cutting strand segment has an overall volume of less than 10 mm³, preferably less than 9 mm³ and particularly preferably less than 5 mm³. Further processing of the sintered cutting strand segment can advantageously take place directly following the sintering operation. By means of the method according to the invention, a cutting strand segment having a complex component structure can advantageously be produced cost effectively, said cutting strand segment having a high hardness, high wear resistance and in particular high hot hardness.

It is furthermore proposed that, in a further step, the cutting strand segment is fed to a finishing device. A “finishing device” should be understood here as meaning in particular a device which is provided to change at least one property of an element or of a part region of the element, in particular by means of coating, by means of hardening etc. Preferably, the finishing device comprises an immersion bath unit or an application unit. However, it is also conceivable for the finishing device alternatively or additionally to comprise a hardening unit. Preferably, finishing by means of an immersion bath or by means of application can be achieved by means of the finishing device. Thus, a long service life of the cutting strand segment can advantageously be achieved.

Preferably, in a further step, in the finishing device, a coating is applied to the cutting strand segment, at least in a part region of the cutting strand segment. The coating is formed preferably by a solder. In this case, the coating is applied in particular by means of an immersion bath or by means of application onto the cutting strand segment. The part region of the cutting strand segment is formed preferably by the cutting element of the cutting strand segment. Advantageously, a property of the part region of the cutting strand segment can be adapted to various use requirements.

In addition, it is proposed that, in a further step, in the finishing device, that part region of the cutting strand segment that is provided with the coating is furnished with particles. Preferably, the particles are in the form of a hard-metal, diamond and/or ceramic material. However, it is also conceivable for the particles to be formed from some other material that appears appropriate to a person skilled in the art. Advantageously, a hard and resistant part region of the cutting strand segment can be achieved. In particular, when the part region is configured as a cutting element, a hard, non-defined cutting edge of the cutting element can advantageously be realized by means of furnishing with particles.

Furthermore, the invention proceeds from a power-tool parting device having at least one guide unit and having at least one cutting strand which has at least one cutting strand segment produced by means of the method according to the invention. The guide unit is provided preferably for guiding the cutting strand. A “guide unit” should be understood here as meaning in particular a unit which is provided to exert on the cutting strand a constraining force at least in a direction perpendicularly to a cutting direction of the cutting strand, in order to specify a movement capability of the cutting strand in the cutting direction. In this connection, the term “provided” should be understood as meaning in particular specially designed and/or specially equipped. Preferably, the guide unit has at least one guide element, in particular a guide groove, through which the cutting strand is guided. Preferably, the cutting strand, as seen in a cutting plane, is guided through the guide unit around a full circumference of the guide unit by means of the guide element, in particular the guide groove.

The expression “cutting plane” is intended here in particular to define a plane in which the cutting strand is moved, in at least one operating state, around a circumference of the guide unit in at least two cutting directions, directed in opposite directions to one another, relative to the guide unit. Preferably, when a workpiece is machined, the cutting plane is oriented at least substantially transversely to a workpiece surface to be machined. The expression “at least substantially transversely” should be understood here as meaning in particular an orientation of a plane and/or a direction relative to a further plane and/or a further direction which preferably deviates from a parallel orientation of the plane and/or the direction relative to the further plane and/or the further direction. However, it is also conceivable for the cutting plane to be oriented, when a workpiece is machined, at least substantially parallel to a workpiece surface to be machined, in particular when the cutting strand is in the form of a grinding means etc. The expression “at least substantially parallel” should be understood here as meaning in particular an orientation of a direction relative to a reference direction, in particular in a plane, wherein the direction has a deviation in particular of less than 8°, advantageously less than 5° and particularly advantageously less than 2° with respect to the reference direction. A “cutting direction” should be understood here as meaning in particular a direction in which the cutting strand is moved in order to create a cutting gap and/or to part off and/or to remove material particles from a workpiece to be machined in at least one operating state as a result of a drive force and/or a drive torque, in particular in the guide unit. Preferably, the cutting strand is moved, in an operating state, in the cutting direction relative to the guide unit.

The expression “closed system” is intended to define here in particular a system which comprises at least two components which retain functionality by means of interaction in a state in which the system is dismounted from a system superordinate to the system, for example a power tool, and/or which are connected captively together in the dismounted state. Preferably, the at least two components of the closed system are connected together at least substantially in a non-detachable manner for an operator. The expression “at least substantially in a non-detachable manner” should be understood here as meaning in particular a connection of at least two components which can be parted from one another only with the aid of parting tools, for example a saw, in particular a mechanical saw etc., and/or chemical parting means, for example solvents etc. The term “sword” is intended here to define in particular a geometrical shape which, as seen in the cutting plane, has a closed outer contour which comprises at least two mutually parallel straight lines and at least two connecting sections, in particular circular arcs, that connect in each case facing ends of the straight lines together. Thus, the guide unit has a geometrical shape which, as seen in the cutting plane, is composed of a rectangle and at least two circular sectors arranged at opposite sides of the rectangle. By means of the configuration according to the invention of the power-tool parting device, a versatile tool for machining workpieces can advantageously be achieved.

Preferably, the power-tool parting device comprises at least one torque transmission element which is mounted at least partially in the guide unit. Preferably, the torque transmission element has a concentric cutout into which a pinion of a drive unit of a portable power tool and/or a gear wheel and/or a toothed shaft of a transmission unit of the portable power tool can engage in a mounted state. The cutout is formed in this case preferably by a hexagonal socket. However, it is also conceivable for the cutout to have some other configuration that appears appropriate to a person skilled in the art. By means of the configuration according to the invention of the power-tool parting device, a closed system can be achieved in a structurally simple manner, said closed system being easily mountable by an operator on a power tool provided for the purpose. It is thus possible advantageously to avoid the individual mounting of components, for example the cutting strand, the guide unit and the torque transmission element, by the operator in order to use the power-tool parting device according to the invention.

It is furthermore proposed that the cutting strand segment is formed in a manner furnished with particles at least in a region of a cutting element of the cutting strand segment. In this case, a cutting tip of the cutting element is preferably furnished with particles. However, it is also conceivable for the entire cutting element to be furnished with particles. Advantageously, a property of the cutting element of the cutting strand segment can be adapted to different use requirements.

Advantageously, the cutting element is formed in a manner furnished with particles of diamonds and/or of a ceramic material. However, it is also conceivable for the cutting element alternatively or additionally to be furnished with particles of a hard-metal material or of some other material that appears appropriate to a person skilled in the art. Thus, by means of furnishing with particles, a hard, non-defined cutting edge of the cutting element can advantageously be realized.

In addition, the invention proceeds from a portable power tool having at least one coupling device which is couplable in a form-fitting and/or force-fitting manner to a power-tool parting device according to the invention. A “portable power tool” should be understood here as meaning in particular a power tool, in particular a handheld power tool, which can be transported by an operator without the use of a transport machine. The portable power tool has in particular a mass which is less than 40 kg, preferably less than 10 kg and particularly preferably less than 5 kg. A portable power tool can advantageously be achieved which is suitable in a particularly advantageous manner for a broad use spectrum.

In this case, the power-tool parting device according to the invention and/or the portable power tool according to the invention should not be limited to the above-described application and embodiment. In particular, the power-tool parting device according to the invention and/or the portable power tool according to the invention can have a number of individual elements, components and units which differs from the number mentioned herein in order to fulfill a functionality described herein.

### DRAWING

Further advantages can be gathered from the following description of the drawing. Exemplary embodiments of the invention are illustrated in the drawing. The drawing, the description and the claims contain numerous features in combination. A person skilled in the art will expediently also consider the features individually and combine them to form appropriate further combinations.

In the drawing:

FIG. 1 shows a schematic illustration of a diagram of a sequence of a method according to the invention for producing at least one cutting strand segment of a cutting strand,

FIG. 2 shows a schematic illustration of a portable power tool according to the invention having a power-tool parting device according to the invention,

FIG. 3 shows a schematic illustration of a detail view of the power-tool parting device according to the invention,

FIG. 4 shows a schematic illustration of a sectional view of a guide unit of the power-tool parting device according to the invention,

FIG. 5 shows a schematic illustration of a sectional view along the line V-V from FIG. 3 of the power-tool parting device according to the invention,

FIG. 6 shows a schematic illustration of a detail view of coupled-together cutting strand segments of the cutting strand,

FIG. 7 shows a schematic illustration of a further detail view of a cutting strand segment of the cutting strand,

FIG. 8 shows a schematic illustration of a detail view of an arrangement of the cutter carrier elements in a guide unit of the power-tool parting device according to the invention,

FIG. 9 shows a schematic illustration of a detail view of a cutting strand segment of a cutting strand of an alternative power-tool parting device according to the invention,

FIG. 10 shows a schematic illustration of a detail view of an alternative cutting strand segment of the cutting strand from FIG. 9,

FIG. 11 shows a schematic illustration of a detail view of a cutting strand segment of a cutting strand of a further, alternative power-tool parting device according to the invention,

FIG. 12 shows a schematic illustration of a detail view of an alternative cutting strand segment of the cutting strand from FIG. 11,

FIG. 13 shows a schematic illustration of a detail view of a cutting strand segment of a cutting strand of a further, alternative power-tool parting device according to the invention, and

FIG. 14 shows a schematic illustration of a detail view of an alternative cutting strand segment of the cutting strand from FIG. 13.

### DESCRIPTION OF THE EXEMPLARY EMBODIMENTS

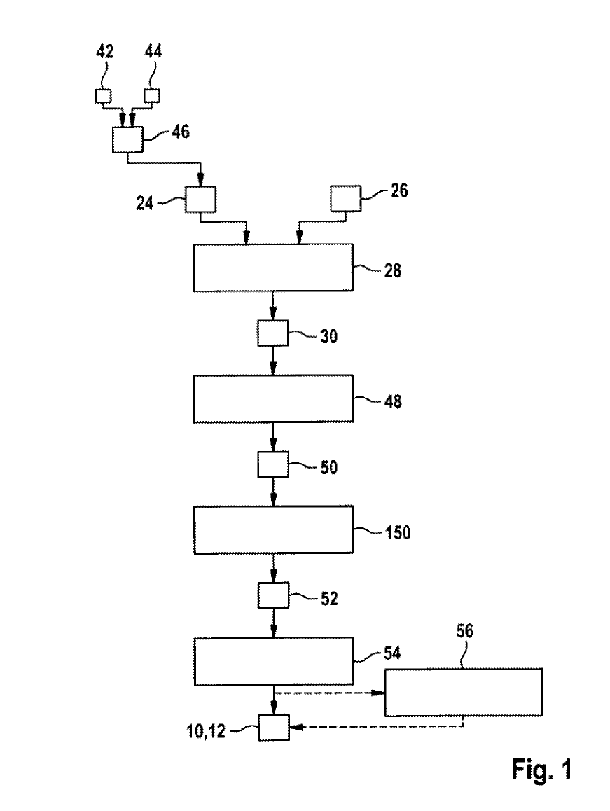

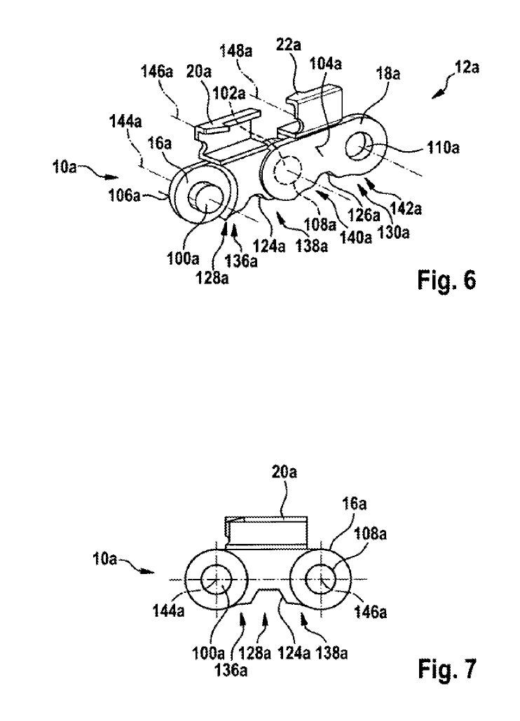

FIG. 1 shows a schematic sequence of a method for producing cutting strand segments 10, 12 of a cutting strand 14, which each comprise a cutter carrier element 16, 18 and a cutting element 20, 22 (provided with letters a in FIGS. 6 and 7). The cutting strand segments 10, 12 are produced from hard metal or ceramic. Thus, depending on the material selected, a powder 24 for producing the cutting strand segments 10, 12 is premixed. When the cutting strand segments 10, 12 are produced from hard metal, the powder 24 has a base powder 42 composed of metallic components and alloying elements 44. The base powder 42 in this case forms a fraction of more than 80% of the powder 24. When the cutting strand segments 10, 12 are produced from ceramic, the powder 24 has a base powder 42′ composed of ceramic components and alloying elements 44′. The base powder 42′ in this case likewise forms a fraction of more than 80% of the powder 24. The fractions of the powder 24 are mixed together beforehand by way of a mixing-in device 46 in the form of a mixer. Thus, when the cutting strand segments 10, 12 are produced from hard metal, a metal powder is used as powder 24. When the cutting strand segments 10, 12 are produced from ceramic, a ceramic powder is used as powder 24. In a first step of the method for producing cutting strand segments 10, 12 of a cutting strand 14, the powder 24 is mixed with binders 26, for example plastics, waxes and/or additives, in a mixing device 28 in the form of a kneader, to form homogeneous granules known as the feedstock 30. The powder 24 and the binders 26 are in this case kneaded by means of the mixing device 28, with addition of heat, to form a viscous mass, are subsequently cooled and are processed to form homogeneous granules known as the feedstock 30.

In a further step of the method, the feedstock 30 is brought into a form of the cutting strand segments 10, 12 by means of an injection-molding operation in an injection-molding machine 48, with in each case the cutter carrier element 16, 18 and the cutting element 20, 22 being formed integrally with one another. In this case, the feedstock 30, after being metered into an injection-molding unit (not illustrated in more detail here) of the injection-molding machine 48, is melted and compacted by means of a screw conveyor (not illustrated in more detail here). By means of the screw conveyor, the feedstock 30 is pressed into injection molds (not illustrated in more detail here) at high-pressure by means of a distributor system of the injection-molding machine 48. The injection molds have negative forms of the geometric shapes of the cutting strand segments 10, 12, said negative forms being at least substantially identical, apart from additionally allowed-for shrinkage, to geometric shapes of the ready-produced cutting strand segments 10, 12. After the feedstock 30 has been pressed into the injection molds, the injection molds are cooled. As a result, the green parts 50, as they are known, of the cutting strand segments 10, 12 are produced. As soon as the injection molds have been cooled to a demolding temperature, the injection molds are opened in a parting plane and the green parts 50 of the cutting strand segments 10, 12 are pushed out of the negative forms of the injection molds by means of ejectors (not illustrated in more detail here) of the injection-molding machine 48.

In a further step of the method, the injection-molded green parts 50 of the cutting strand segments 10, 12 are subjected to chemical binder removal by means of a binder removal device 150. In this case, the binders 26 are chemically extracted from the green parts 50. However, it is also conceivable for the injection-molded green parts 50 of the cutting strand segments 10, 12 to be subjected to thermal binder removal by means of the binder removal device 150 in order to thermally extract the binders. By means of the binder removal, the brown parts 52, as they are known, of the cutting strand segments 10, 12 are produced. The brown parts 52 have an open-pore structure. In a further step of the method, the brown parts 52 of the cutting strand segments 10, 12 are sintered by means of a sintering device 54. The brown parts 52 of the cutting strand segments 10, 12 can additionally be subjected to thermal binder removal prior to a sintering operation by means of the sintering device 54. The cutting strand segments 10, 12 are formed completely from hard metal or completely from ceramic by means of the method. Thus, the cutter carrier elements 16, 18 and the cutting elements 20, 22, which are formed integrally with the cutter carrier elements 16, 18, are likewise formed completely from hard metal or completely from ceramic. The cutting strand segments 10, 12 are already in the form of finished parts after the sintering operation and can be connected together to form the cutting strand 14.

In order to be adapted to different working requirements of the cutting strand 14, the cutting strand segments 10, 12 can be further processed or finished by means of the method. The cutting strand segments 10, 12 are in this case fed, in a further step following the sintering operation, to a finishing device 56 in order to finish the cutting strand segments 10, 12. In the finishing device 56, a coating is applied to the cutting strand segments 10, 12, at least in a part region of the cutting strand segments 10, 12. The part region of the cutting strand segments 10, 12 is formed by the cutting elements 20, 22. In this case, the cutting strand segments 10, 12 with the cutting elements 20, 22 are guided through an immersion bath unit (not illustrated in more detail here) of the finishing device 56. In the immersion bath unit, the cutting elements 20, 22 are coated at least partially with a solder. However, it is also conceivable for the cutting elements 20, 22 to be coated with a solder by means of an application unit of the finishing device 56. In a further step, in the finishing device 56, those part regions of the cutting strand segments 10, that are provided with the coating are furnished with particles. In this case, the particles are furnished with particles either by means of passing through a further immersion bath or by means of the particles being pressed onto those part regions of the cutting strand segments 10, 12 that are provided with the coating. The particles are in the form of diamond particles, hard metal particles or ceramic particles. However, it is also conceivable for the cutting strand segments 10, 12 to be coated, at least in a part region, as an alternative to the immersion bath, by means of a chemical vapor deposition unit (not illustrated in more detail here) of the finishing device 56. Other methods that appear appropriate to a person skilled in the art for coating the cutting elements 20, 22 of the cutting strand segment 10, 12 are likewise conceivable, for example by means of a physical vapor deposition method (PVD method) or by means of a plasma assisted chemical vapor deposition method (PACVD method) etc. After the sintering operation and after a finishing operation, the cutting strand segments 10, 12 are in the form of finished parts which are connected together in a further working process in order to form the cutting strand 14.

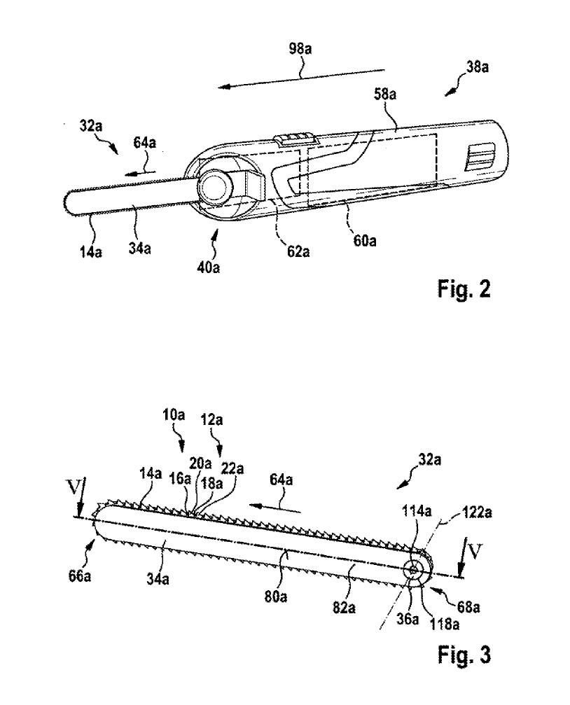

FIGS. 2 to 14 show various exemplary embodiments of cutting strand segments which are produced by means of the above-described method. In this case, in order to distinguish between the exemplary embodiments, the letters a to d have been added to the reference signs of the exemplary embodiments. The following description of the exemplary embodiments is limited substantially to the differences in the geometric configuration of the cutting strand segments, produced by means of the method, of the exemplary embodiments.

FIG. 2 shows a portable power tool 38a having a power-tool parting device 32a which together form a power-tool system. The power-tool parting device 32a comprises a cutting strand 14a and a guide unit 34a for guiding the cutting strand 14a. The portable power tool 38a has a coupling device 40a for coupling in a form-fitting and/or force-fitting manner to the power-tool parting device 32a. The coupling device 40a can in this case be in the form of a bayonet closure and/or of some other coupling device that appears appropriate to a person skilled in the art. Furthermore, the portable power tool 38a has a power-tool housing 58a which encloses a drive unit 60a and a transmission unit 62a of the portable power tool 38a. The drive unit 60a and the transmission unit 62a are operatively connected together in a manner already known to a person skilled in the art in order to produce a drive moment that is transmissible to the power-tool parting device 32a. The transmission unit 62a is in the form of an angular gear. The drive unit 60a is in the form of an electric motor unit. However, it is also conceivable for the drive unit 60a and/or the transmission unit 62a to have some other configuration that appears appropriate to a person skilled in the art. The drive unit 60a is provided to drive the cutting strand 14a of the power-tool parting device 32a in at least one operating state at a cutting speed less than 6 m/s. In this case, the portable power tool 38a has at least one operating mode in which the cutting strand 14a can be driven in the guide unit 34a of the power-tool parting device 32a in a cutting direction 64a of the cutting strand 14a at a cutting speed of less than 6 m/s.

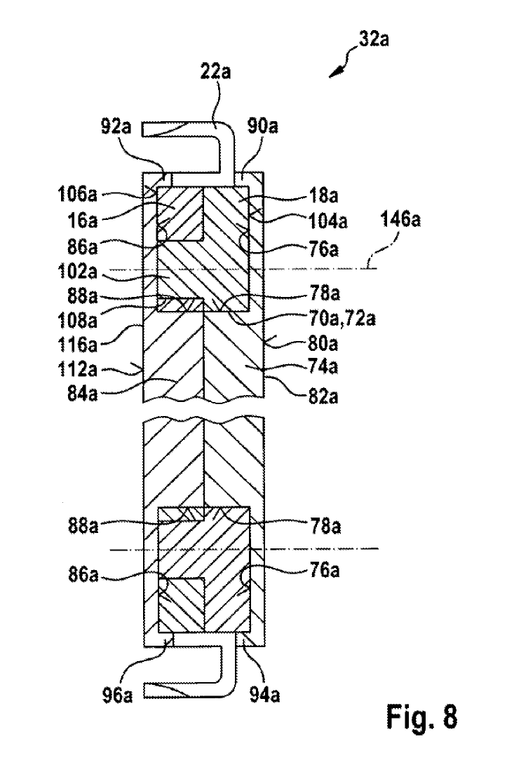

FIG. 3 shows the power-tool parting device 32a in a state decoupled from the coupling device 40a of the portable power tool 38a. The power-tool parting device 32a has the cutting strand 14a and the guide unit 34a, which together form a closed system. The guide unit 34a is in the form of a sword. Furthermore, the guide unit 34a, as seen in the cutting plane of the cutting strand 14a, has at least two convexly formed ends 66a, 68a. The convexly formed ends 66a, 68a of the guide unit 34a are arranged on two sides, facing away from one another, of the guide unit 34a. The cutting strand 14a is guided by means of the guide unit 34a. To this end, the guide unit 34a has at least one guide element 70a (FIG. 8), by means of which the cutting strand 14a is guided. The guide element 70a is in the form of a guide groove 72a (FIG. 8) which extends in the cutting plane of the cutting strand 14a around an entire circumference of the guide unit 34a. In this case, the cutting strand 14a is guided by means of peripheral regions, adjoining the guide groove 72a, of the guide unit 34a. However, it is also conceivable for the guide element 70a to be configured in some other manner which appears appropriate to a person skilled in the art, for example as a rib-like formation on the guide unit 34a, said rib-like formation engaging in a cutout on the cutting strand 14a. The cutting strand 14a is, as seen in a plane extending perpendicularly to the cutting plane, surrounded by the guide unit 34a on three sides (FIG. 8). During operation, the cutting strand 14a is moved relative to the guide unit 34a in circulation around the circumference in the guide groove 72a.

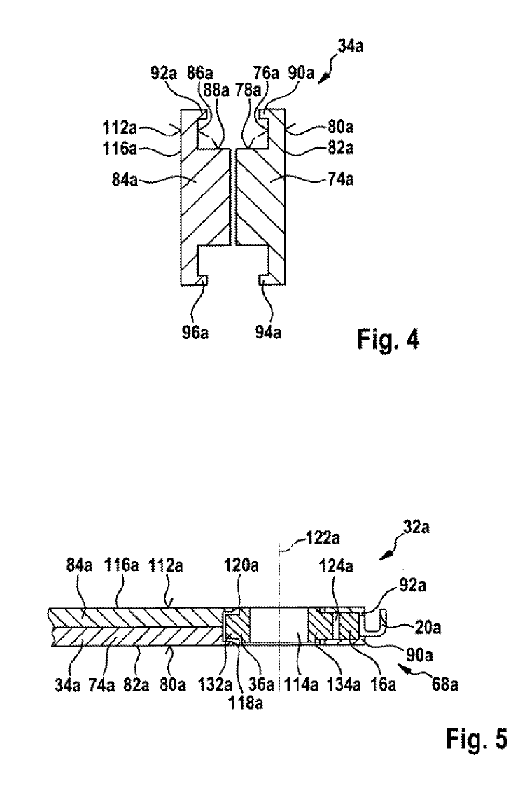

FIG. 4 shows a sectional view of the guide unit 34a in a dismounted state. The guide unit 34a comprises a main guide-unit element 74a which has two guide surfaces 76a, 78a that have different orientations from one another and are provided in a mounted state of the guide unit 34a for guiding the cutting strand 14a arranged in the guide unit 34a. The guide surfaces 76a, 78a are formed in a manner adjoining one another. In this case, the guide surfaces 76a, 78a are arranged at least substantially perpendicularly to one another. One of the guide surfaces 76a, 78a extends at least substantially parallel to an outer surface 80a of an outer wall 82a of the main guide-unit element 74a. The guide surface 76a extending parallel to the outer surface 80a of the outer wall 82a is composed of two rectangular surfaces and two semicircular ring surfaces which are arranged in a manner adjoining one another around a circumference of the main guide-unit element 74a and have a closed profile. Thus, the guide surface 76a extending parallel to the outer surface 80a of the outer wall 82a extends around the entire circumference of the main guide-unit element 74a, as seen in a circumferential direction extending in a mounted state in a cutting plane of the cutting strand 14a. Furthermore, one of the guide surfaces 76a, 78a extends at least substantially perpendicularly to the outer surface 80a of the outer wall 82a. The guide surface 78a extending perpendicularly to the outer surface 80a of the outer wall 82a extends around the entire circumference of the main guide-unit element 74a.

In addition, the guide unit 34a has a further main guide-unit element 84a which has two further guide surfaces 86a, 88a which have different orientations from one another and which are provided, in a mounted state of the guide unit 34a, to guide the cutting strand 14a arranged in the guide unit 34a. The further guide surfaces 86a, 88a have an analogous arrangement on the further main guide-unit element 84a to an arrangement of the guide surfaces 76a, 78a on the main guide-unit element 74a. Furthermore, the further guide surfaces 86a, 88a, of the further main guide-unit element 84a have an analogous embodiment to the guide surfaces 76a, 78a of the main guide-unit element 74a. In a mounted state, the main guide-unit element 74a and the further main guide-unit element 84a are connected together in a detachable manner in the cutting plane of the cutting strand 14a by means of a form-fitting and/or a force-fitting connection. In this case, in a mounted state, the main guide-unit element 74a and the further main guide-unit element 84a form the guide element 70a of the guide unit 34a for guiding the cutting strand 14a. The main guide-unit element 74a and the further main guide-unit element 84a are each formed in a T-shaped manner.

However, in an alternative configuration not illustrated in more detail here, it is also conceivable for the guide unit 34a, to comprise two lateral guide walls and one guide-means element firmly connected to the two lateral guide walls. In this case, the two lateral guide walls each form a guide surface, extending at least substantially parallel to an outer surface of one of the lateral guide walls, of the guide unit 34a. The guide-means element forms, in the alternative configuration, not illustrated here, of the guide unit 34a, a guide surface extending at least substantially perpendicularly to the outer surface of one of the lateral guide walls.

Furthermore, the guide unit 34a has four segment guide elements 90a, 92a, 94a, 96a for guiding the cutting strand 14a, wherein in each case two of the four segment guide elements 90a, 92a, 94a, 96a are provided to limit a movement of the cutting strand 14a, as seen in a direction facing away from the guide unit 34a, in each case in a direction extending at least substantially parallel to the cutting plane of the cutting strand 14a (FIG. 8). The directions in which in each case two of the four segment guide elements 90a, 92a, 94a, 96a limit a movement of the cutting strand 14a in a direction facing away from the guide unit 34a in this case extend in each case at least substantially perpendicularly to straight lines of an outer contour of the guide unit 34a. In this case, in each case two of the four segment guide elements 90a, 92a, 94a, 96a are arranged on the guide unit 34a in a region of one of the two straight lines of the outer contour. Thus, two of the four segment guide elements 90a, 92a, 94a, 96a are arranged in a part region of the guide unit 34a, in which part region the cutting strand 14a is moved in a direction facing away from the portable power tool 38a, in an operating state in which the cutting strand 14a moves in circulation in the cutting direction 64a around the circumference of the guide unit 34a, as seen in a main direction of extent 98a of the portable power tool 38a. Furthermore, two of the four segment guide elements 90a, 92a, 94a, 96a are arranged in a part region of the guide unit 34a, in which part region the cutting strand 14a is moved in a direction facing toward the portable power tool 38a, in an operating state in which the cutting strand 14a moves in circulation in the cutting direction 64a around the circumference of the guide unit 34a, as seen in the main direction of extent 98a. The four segment guide elements 90a, 92a, 94a, 96a are provided to hold the cutting strand 14a in the guide groove 72a in regions of the straight lines of the outer contour.

The cutting strand 14a comprises a multiplicity of cutting strand segments 10a, 12a which are connected together and comprise cutter carrier elements 16a, 18a. The cutter carrier elements 16a, 18a are each connected together by means of at least one connecting element 100a, 102a of the cutting strand 14a, said connecting element 100a, 102a terminating at least substantially flush with at least one of two outer surfaces 104a, 106a of the cutter carrier elements 16a, 18a which are connected together (FIGS. 6 and 8). The connecting elements 100a, 102a are formed in a pin-like manner. The outer surfaces 104a, 106a extend at least substantially parallel to the cutting plane in a state of the cutting strand 14a in which the latter is arranged in the guide groove 72a. Depending on the application, a person skilled in the art will select a number of cutter carrier elements 16a, 18a which is suitable for the cutting strand 14a. The cutter carrier elements 16a, 18a are each formed integrally with one of the connecting elements 100a, 102a. Furthermore, the cutter carrier elements 16a, 18a each have a connecting cutout 108a, 110a for receiving one of the connecting elements 100a, 102a of the cutter carrier elements 16a, 18a which are connected together. The connecting elements 100a, 102a are guided by means of the guide unit 34a (FIG. 8). In this case, the connecting elements 100a, 102a are arranged in the guide groove 72a in a mounted state of the cutting strand 14a. The connecting elements 100a, 102a can, as seen in a plane extending perpendicularly to the cutting plane, be supported on the guide surface 76a extending at least substantially parallel to the outer surface 80a, and on the further guide surface 86a extending at least substantially parallel to an outer surface 112a of the further main guide-unit element 84a.

Furthermore, the cutting strand 14a has a multiplicity of cutting strand segments 10a, 12a which comprise cutting elements 20a, 22a. In this case, it is conceivable for some of the cutting strand segments 10a, 12a to be formed in a manner decoupled from cutting elements and instead to have stripping elements. A number of the cutting elements 20a, 22a is dependent on a number of cutter carrier elements 16a, 18a. Depending on the number of cutter carrier elements 16a, 18a, a person skilled in the art will select a suitable number of cutting elements 20a, 22a. The cutting elements 20a, 22a are each formed integrally with one of the cutter carrier elements 16a, 18a. Furthermore, the cutting elements 20a, 22a extend in the cutting plane beyond the guide groove 72a in order to allow material particles to be parted off and/or removed from a workpiece (not illustrated in more detail here) to be machined. The cutting elements 20a, 22a can for example be in the form of a full-chisel, half-chisel or other cutter types that appear appropriate to a person skilled in the art and are provided so as to allow material particles to be parted off and/or removed from a workpiece to be machined. The cutting strand 14a is formed in an endless manner. Thus, the cutting strand 14a is in the form of a cutting chain. The cutter carrier elements 16a, 18a are in this case in the form of chain links which are connected together by means of the pin-like connecting elements 100a, 102a.

In order to drive the cutting strand 14a, the power-tool parting device 32a has a torque transmission element 36a which is connectable to the drive unit 60a and/or the transmission unit 62a in order to transmit forces and/or torques to the cutting strand 14a. To this end, the torque transmission element 36a has a coupling cutout 114a into which a pinion (not illustrated in more detail here) of the drive unit 60a and/or a gear wheel (not illustrated in more detail here) and/or a toothed shaft (not illustrated in more detail here) of the transmission unit 62a engages in a mounted state. The coupling cutout 114a is arranged concentrically in the torque transmission element 36a. Furthermore, the torque transmission element 36a is in the form of a gear wheel. The torque transmission element 36a is mounted at least partially in the guide unit 34a. In this case, the torque transmission element 36a is arranged, as seen in a direction perpendicularly to the cutting plane, at least partially between the outer wall 82a of the main guide-unit element 74a and an outer wall 116a of the further main guide-unit element 84a (FIG. 5).

The torque transmission element 36a is arranged with a part region in a cutout 118a of the outer wall 82a of the main guide-unit element 74a and in a cutout 120a of the outer wall 116a of the further main guide-unit element 84a. In this case, the torque transmission element 36a has an extent, at least in the part region arranged in the cutouts 118a, 120a, along a rotation axis 122a of the torque transmission element 36a, said extent terminating flush with the outer surface 80a of the main guide-unit element 74a and/or the outer surface 112a of the further main guide-unit element 84a. Furthermore, that part region of the torque transmission element 36a that is arranged in the cutouts 118a, 120a has an outer dimension, extending at least substantially perpendicularly to the rotation axis 122a of the torque transmission element 36a, which is at least 0.1 mm smaller than an inner dimension, extending at least substantially perpendicularly to the rotation axis 122a of the torque transmission element 36a, of the cutouts 118a, 120a. That part region of the torque transmission element 36a that is arranged in the cutouts 118a, 120a is arranged, in a direction extending perpendicularly to the rotation axis 122a, in each case at a distance from a periphery, delimiting the respective cutout 118a, 120a, of the outer wall 82a of the main guide-unit element 74a and the outer wall 116a of the further main guide-unit element 84a. Thus, that part region of the torque transmission element 36a that is arranged in the cutouts 118a, 120a has a clearance within the cutouts 118a, 120a.

The cutter carrier elements 16a, 18a of the cutting strand 14a each have a drive cutout 124a, 126a which is arranged, in each case in a mounted state, on a side 128a, 130a, facing the torque transmission element 36a, of the respective cutter carrier element 16a, 18a. The torque transmission element 36a engages, in at least one operating state, in the drive cutouts 124a, 126a in order to drive the cutting strand 14a. The torque transmission element 36a comprises teeth 132a, 134a which are provided to engage, in at least one operating state, in the drive cutout 124a 126a of the cutter carrier element 16a, 18a in order to drive the cutting strand 14a. Furthermore, the sides 128a, 130a, facing the torque transmission element 36a, of the cutter carrier elements 16a, 18a are formed in a circularly arcuate manner. Those sides 128a, 130a of the cutter carrier elements 16a, 18a that face the torque transmission element 36a in a mounted state are each configured in a circularly arcuate manner in part regions 136a, 138a, 140a, 142a, as seen between a center axis 144a of the respective connecting element 100a, 102a and a center axis 146a, 148a of the respective connecting cutout 108a, 110a. The circularly arcuate part regions 136a, 138a, 140a, 142a are each formed in a manner adjoining the drive cutouts 124a, 126a in which the torque transmission element 36a engages. In this case, the circularly arcuate part regions 136a, 138a, 140a, 142a have a radius which corresponds to a radius of a profile of the guide groove 72a at the convex ends 66a, 68a. The part regions 136a, 138a, 140a, 142a are formed in a concave manner (FIG. 7).

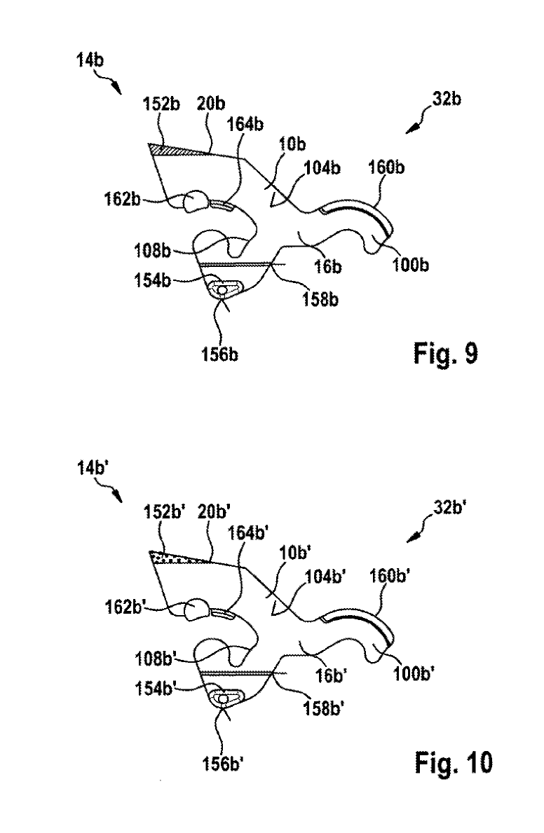

FIGS. 9 to 14 illustrate alternative exemplary embodiments. Substantially identical components, features and functions are designated in principle with the same reference signs. The following description is limited substantially to the differences with respect to the first exemplary embodiment described in FIGS. 2 to 8, it being possible to refer to the description of the first exemplary embodiment in FIGS. 2 to 8 with regard to identical components, features and functions.

FIG. 9 shows an alternative cutting strand segment 10b of a cutting strand 14b of a power-tool parting device 32b. The cutting strand segment 10b comprises at least one cutter carrier element 16b and at least one cutting element 20b. The cutter carrier element 16b and the cutting element 20b are formed integrally. The cutting element 20b has in this case a cutting layer 152b having at least titanium carbide. The cutting layer 152b is applied to the cutting element 20b by means of a CVD method. However, it is also conceivable for the cutting layer 152b alternatively or additionally to comprise a different material, for example titanium nitride, titanium carbonitride, aluminum oxide, titanium aluminum nitride, chromium nitride or zirconium carbonitride. In addition, it is also conceivable for the cutting layer 152b to be applied by some other method that appears appropriate to a person skilled in the art, for example by means of a PVD or PACVD method.

The cutter carrier element 16b has at least one segment counter-guide element 154b which is provided to limit a movement of the cutter carrier element 16b, as seen in a state arranged in a guide unit (not illustrated in more detail here) in a direction facing away from the guide unit, at least in the direction extending at least substantially parallel to a cutting plane of the cutting strand 14b. The segment counter-guide element 154b is formed by a transverse extension which extends at least substantially perpendicularly to the cutting plane of the cutting strand 14b. In this case the segment counter-guide element 154b delimits a longitudinal groove. For the purpose of limiting movement, the segment counter-guide element 154b is provided to interact with a segment guide element (not illustrated in more detail here) arranged on an inner surface, facing the cutter carrier element 16b, of a guide wall (not illustrated in more detail here) of the guide unit and in the form of a rib or punched-out section. The segment guide element is formed in a manner corresponding to the segment counter-guide element 154b. Overall, the cutting strand 14b has a multiplicity of cutting strand segments 10b which each comprise a cutter carrier element 16b and a cutting element 20b. Each cutter carrier element 16b comprises in this case at least one segment counter-guide element 154b which is provided to limit a movement of the cutter carrier element 16b, as seen in a state arranged in the guide unit in a direction facing away from the guide unit, at least in a direction extending at least substantially parallel to the cutting plane of the cutting strand 14b.

In addition, each of the cutter carrier elements 16b has a compressive-force transmission surface 156b (FIGS. 7 and 8). The compressive-force transmission surface 156b is provided to support compressive forces, which act on the cutting strand 14b when a workpiece (not illustrated in more detail here) is machined, by means of interaction with a compressive-force absorbing region (not illustrated in more detail here) of the guide unit. The compressive-force absorbing region of the guide unit is in this case arranged, as seen in a direction extending at least substantially perpendicularly to the cutting plane of the cutting strand 14b, between two outer surfaces (not illustrated in more detail here) of the guide unit, said outer surfaces extending at least substantially parallel to one another.

The cutter carrier element 16b furthermore has a drive surface 158b which is provided to interact with drive surfaces of a torque transmission element (not illustrated in more detail here) in order to drive the cutting strand 14b. The drive surfaces of the torque transmission element are in this case in the form of tooth flanks. The drive surface 158b of the cutter carrier element 16b is in this case formed in a manner corresponding to the drive surfaces of the torque transmission element. When the cutting strand 14b is driven, the tooth flanks of the torque transmission element bear temporarily against the drive surface 158b in order to transmit drive forces.

In order to form the cutting strand 14b, the cutter carrier element 16b comprises at least one connecting element 100b which terminates at least substantially flush with at least one outer surface 104b of the cutter carrier element 16b. In this case, the connecting element 100b terminates, as seen along a transverse axis of the connecting element 100b, flush with the two outer surfaces 104b of the cutter carrier element 16b (not illustrated in more detail here). The transverse axis of the connecting element 100b extends at least substantially perpendicularly to the cutting plane of the cutting strand 14b. The connecting element 100b is formed integrally with the cutter carrier element 16b. In this case, the connecting element 100b is in the form of a longitudinal extension of the cutter carrier element 16b. The connecting element 100b in the form of a longitudinal extension extends at least substantially along a longitudinal extent of the cutter carrier element 16b. Thus, the connecting element 100b in the form of a longitudinal extension extends at least substantially parallel to the cutting plane of the cutting strand 14b. In this case, the longitudinal extension is formed in a hook-like manner. In this case, the longitudinal extension is formed in a manner deviating from a rod-like extension on which a circular form-fitting element is integrally formed and/or in a manner deviating from a semicircular extension. Each cutter carrier element 16b of the cutting strand segments 10b of the cutting strand 14b has in each case a connecting element 100b in the form of a longitudinal extension and in each case a connecting cutout 108b formed in a manner corresponding to the connecting element 100b. In order to form the cutting strand 14b in the form of a cutting chain, the individual connecting elements 100b of the cutter carrier elements 16b are provided in each case to realize a form-fitting connection between the cutter carrier elements 16b by means of interaction with a connecting cutout 108b, the cutter carrier elements 16b being connected pivotably together by means of said form-fitting connection.

Furthermore, the connecting element 100b in the form of a longitudinal extension has a transverse securing region 160b on one side. The transverse securing region 160b is provided to at least largely prevent a transverse movement of the cutter carrier element 16b in at least two oppositely directed directions in a coupled state relative to the further cutter carrier element, by means of interaction with at least one transverse securing element of a further cutter carrier element (not illustrated in more detail here), connected to the cutter carrier element 16b, of the cutting strand segments 10b of the cutting strand 14b. In this case, the transverse securing region 160b is in the form of a rib. However, it is also conceivable for the transverse securing region 160b to have some other configuration that appears appropriate to a person skilled in the art, for example a configuration as a groove etc. The transverse securing region 160b is arranged on a side, facing the cutting element 20b formed integrally with the cutter carrier element 16b, of the connecting element 100b.

Furthermore, the cutter carrier element 16b has two transverse securing elements 162b, 164b which are provided to interact, in the state of the cutter carrier element 16b in which it is coupled to the further cutter carrier element, with a transverse securing region of the further cutter carrier element. The transverse securing elements 162b, 164b are arranged in each case in a peripheral region, delimiting the connecting cutout 108b, of the cutter carrier element 16b. In this case, the transverse securing elements 162b, 164b are formed integrally with the cutter carrier element 16b. The transverse securing elements 162b, 164b are in each case integrally formed on the cutter carrier element 16b by means of an embossing method. Thus, the transverse securing elements 162b, 164b extend, as seen in a direction extending at least substantially perpendicularly to the cutting plane of the cutting strand 14b, at most as far as the outer surfaces 104b of the cutter carrier element 16b. However, it is also conceivable for the transverse securing elements 162b, 164b to be integrally formed on the cutter carrier element 16b by means of some other method that appears appropriate to a person skilled in the art, for example by means of a welding method, by means of an adhesive-bonding method, by means of a stamping method, by means of a bending method etc.

In addition, the transverse securing elements 162b, 164b are arranged, as seen in a direction extending at least substantially perpendicularly to the cutting plane of the cutting strand 14b, on sides of the cutter carrier element 16b that face away from one another. Furthermore, the transverse securing elements 162b, 164b are arranged on the cutter carrier element 16b in an offset manner relative to one another. Thus, with respect to the cutting plane of the cutting strand 14b, the transverse securing elements 162b, 164b are arranged on the cutter carrier element 16b in an arrangement differing from a mirror-symmetrical arrangement. In this case, the transverse securing elements 162b, 164b are in the form of partial extensions on a peripheral region of the connecting cutout 108b. However, it is also conceivable for the transverse securing elements 162b, 164b to have some other configuration and/or arrangement that appears appropriate to a person skilled in the art, for example a configuration as webs extending in parallel which delimit a groove-shaped cutout in the peripheral region of the connecting cutout 108b, as seen in a direction extending at least substantially perpendicularly to the cutting plane of the cutting strand 14b.

FIG. 10 shows a cutting strand segment 10b′ formed in an alternative manner to the cutting strand segment 10b illustrated in FIG. 9. The cutting strand segment 10b′ is formed at least substantially analogously to the cutting strand segment 10b illustrated in FIG. 9. In contrast to the cutting strand segment 10b from FIG. 9, the cutting strand segment 10b′ from FIG. 10 has a cutting element 20b′ furnished with particles. In this case, the cutting element 20b′ has a coating into which particles have been introduced. The particles are in this case in the form of diamond particles. However, it is also conceivable for the particles to have some other configuration that appears appropriate to a person skilled in the art, for example a configuration as hard metal particles, as ceramic particles etc.

FIG. 11 shows a further, alternative cutting strand segment 10c of a cutting strand 14c of a power-tool parting device 32c. The cutting strand segment 10c comprises at least one cutter carrier element 16c and at least one cutting element 20c. The cutter carrier element 16c and the cutting element 20c are formed integrally. The cutting element 20c has in this case a cutting layer 152c having at least titanium carbide. In order to form the cutting strand 14c, the cutter carrier element 16c comprises at least one connecting element 100c which terminates at least substantially flush with at least one outer surface 104c of the cutter carrier element 16c. The connecting element 100c is formed in a pin-like manner. In this case, the connecting element 100c extends in a direction extending at least substantially perpendicularly to a cutting plane of the cutting strand 14c. Furthermore, the cutter carrier element 16c has a connecting cutout 108c. In order to form the cutting strand 14c formed as a cutting chain, the connecting cutout 108c is provided to realize, by means of interaction with a connecting element of a further cutter carrier element of a further cutting strand segment (not illustrated in more detail here) of the cutting strand 14c, a form-fitting connection between the cutter carrier element 16c and the further cutter carrier element, the cutter carrier element 16c and the further cutter carrier element being connected pivotably together by means of said form-fitting connection.

Furthermore, the cutter carrier element 16c has at least one transverse securing element 162c which is provided to at least largely prevent a transverse movement of the cutter carrier element 16c in a coupled state relative to the further cutter carrier element. In addition, the cutter carrier element 16c has a transverse securing region 160c. The transverse securing element 162c is in the form of an extension. In this case, the transverse securing element 162c is arranged in a coupling region 166c of the cutter carrier element 16c. Thus, the transverse securing element 162c delimits, together with the coupling region 166c, a groove-like cutout, extending at least substantially parallel to the cutting plane of the cutting strand 14c, in order to receive a transverse securing region (not illustrated in more detail here) of the further cutter carrier element in a coupled state. Arranged in the coupling region 166c is the connecting element 100c, which is introduced into a connecting cutout of the further cutter carrier element in order to realize a form-fitting connection when the cutting strand 14c is mounted. The transverse securing element 162c is formed integrally with the cutter carrier element 16c. In this case, the transverse securing element 162c is integrally formed on the cutter carrier element 16c by means of an embossing method.

The transverse securing region 160c is arranged, as seen in a cutting direction of the cutting strand 14c, on a side of the cutter carrier element 16c which faces away from the coupling region 166c. In this case, the transverse securing region 160c is in the form of a rib-like longitudinal extension. However, it is also conceivable for the transverse securing region 160c to have some other configuration that appears appropriate to a person skilled in the art, for example a configuration as a groove etc. The transverse securing element 162c covers the transverse securing region of the further cutter carrier element in a coupled state in order to at least largely prevent a transverse movement of the cutter carrier element 16c relative to the further cutter carrier element in at least two directions oriented in opposite directions. In addition, the cutter carrier element 16c comprises at least one segment counter-guide element 154c. Furthermore, the cutter carrier element 16c has a compressive-force transmission surface 156c.

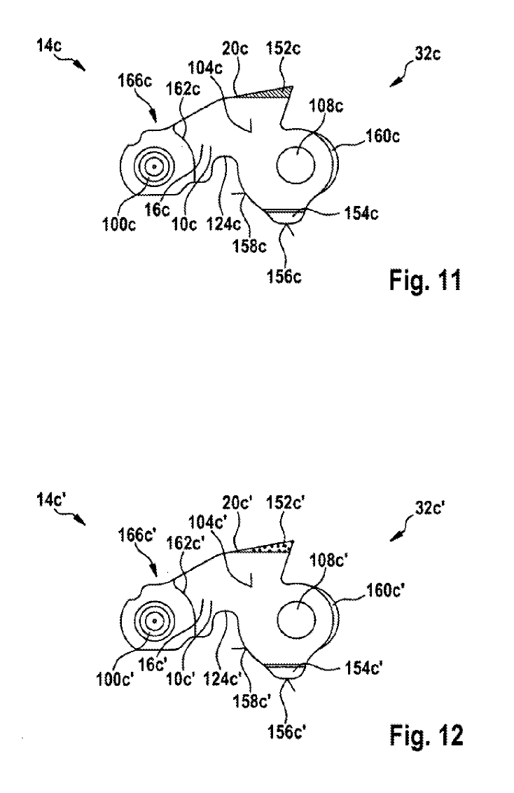

FIG. 12 shows a cutting strand segment 10c′ formed in an alternative manner to the cutting strand segment 10c illustrated in FIG. 11. The cutting strand segment 10c′ is formed at least substantially analogously to the cutting strand segment 10c illustrated in FIG. 11. In contrast to the cutting strand segment 10c from FIG. 11, the cutting strand segment 10c′ from FIG. 12 has a cutting element 20c′ furnished with particles. In this case, the cutting element 20c′ has a coating into which particles have been introduced. The particles are in this case in the form of diamond particles. However, it is also conceivable for the particles to have some other configuration that appears appropriate to a person skilled in the art, for example a configuration as hard metal particles, as ceramic particles etc.

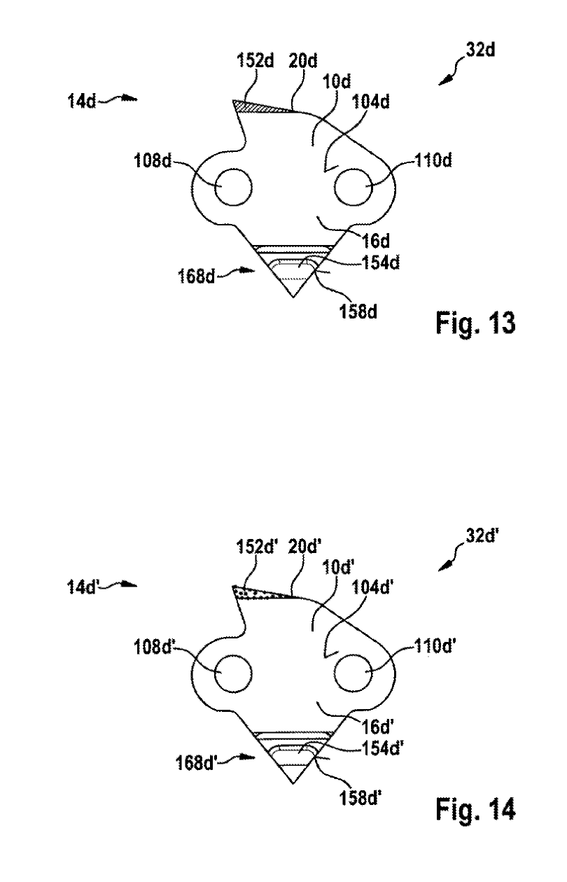

FIG. 13 shows a further, alternative cutting strand segment 10d of a cutting strand 14c of a power-tool parting device 32d. The cutting strand segment 10d comprises at least one cutter carrier element 16d and at least one cutting element 20d. The cutter carrier element 16d and the cutting element 20d are formed integrally. The cutting element 20d has in this case a cutting layer 152d having at least titanium carbide. In order to form the cutting strand 14d, the cutter carrier element 16d comprises two connecting cutouts 108d, 110d, into which a pin-like connecting element (not illustrated in more detail here) of a further cutter carrier element (not illustrated in more detail here) of the cutting strand 14d is introducible. In addition, the cutter carrier element 16d comprises at least one segment counter-guide element 154d. Furthermore, the cutter carrier element 16d comprises a triangular drive region 166d. In this case, the segment counter-guide element 154d is arranged in the drive region 166d. Furthermore, a drive surface 158d of the cutter carrier element 16d is arranged in the drive region 166d.

FIG. 14 shows a cutting strand segment 10d′ formed in an alternative manner to the cutting strand segment 10d illustrated in FIG. 13. The cutting strand segment 10d′ is formed at least substantially analogously to the cutting strand segment 10d illustrated in FIG. 13. In contrast to the cutting strand segment 10d from FIG. 13, the cutting strand segment 10d′ from FIG. 14 has a cutting element 20d′ furnished with particles. In this case, the cutting element 20d′ has a coating into which particles have been introduced. The particles are in this case in the form of diamond particles. However, it is also conceivable for the particles to have some other configuration that appears appropriate to a person skilled in the art, for example a configuration as hard metal particles, as ceramic particles etc.

1. A method for producing at least one cutting strand segment of a cutting strand having at least one cutter carrier element and a cutting element, the method comprising:
mixing at least one powder with at least one binder in a mixing device to form a feedstock.

2. The method as claimed in claim 1, wherein the at least one powder includes a metal powder.

3. The method as claimed in claim 1, wherein the at least one powder includes a ceramic powder.

4. The method as claimed in claim 1, further comprising:
injection-molding the feedstock into a form of the cutting strand segment; and
forming the cutter carrier element and the cutting element integrally with one another.

5. The method as claimed in claim 4, further comprising:
subjecting the injection-molded cutting strand segment to chemical binder removal.

6. The method as claimed in claim 4, further comprising:
subjecting the cutting strand segment to thermal binder removal.

7. The method as claimed in claim 5, further comprising:
sintering the cutting strand segment.

8. The method as claimed in claim 7, further comprising:
feeding the cutting strand segment to a finishing device.

9. The method as claimed in claim 8, further comprising:
in the finishing device, applying a coating to at least a part region of the cutting strand segment.

10. The method as claimed in claim 9, further comprising:
in the finishing device furnishing the part region of the cutting strand segment that is provided with the coating with particles.

11. A power-tool parting device comprising:
at least one guide unit; and
at least one cutting strand including at least one cutting strand segment produced by mixing at least one powder with at least one binder in a mixing device to form a feedstock.

12. The power-tool parting device as claimed in claim 11, further comprising:
at least one torque transmission element mounted at least partially in the at least one guide unit.

13. The power-tool parting device as claimed in claim 11, wherein the cutting strand segment is furnished with particles at least in a region of a cutting element of the cutting strand segment.

14. The power-tool parting device as claimed in claim 13, wherein the cutting element is furnished with particles of at least one of diamonds and a ceramic material.

15. A portable power tool comprising:
at least one coupling device configured to couple in a form-fitting and/or force-fitting manner to a power-tool parting device having at least one guide unit and at least one cutting strand including at least one cutting strand segment produced by mixing at least one powder with at least one binder in a mixing device to form a feedstock.
